(19) United States
(12) Patent Application Publication
(10) Pub. No.: US 2003/0141642 A1
(43) Pub. Date: Jul. 31, 2003

(54) Elastic wheel

(76) Inventors: Tatsuro Uchida, Tokyo (JP); Hirohumi Kikuchi, Kanagawa (JP); Katsumi Tashiro, Tokyo (JP); Takeshi Suga, Kanagawa (JP)

Correspondence Address: SUGHRUE MION, PLLC, 2100 PENNSYLVANIA AVENUE, N.W., WASHINGTON, DC, 20037, US

(21) Appl. No.: 10/312,868

(22) PCT Filed: Jul. 9, 2001
(86) PCT No.: PCT/JP01/05940

(30) Foreign Application Priority Data
Jul. 10, 2000 (JP) 2000-208040
Jul. 10, 2000 (JP) 2000-208041
Dec. 13, 2000 (JP) 2000-378281

(51) Int. Cl. F16F 1/18

(52) U.S. Cl. 267/240

(57) ABSTRACT

An elastic wheel comprising a disk (1), a rim (3) supporting a tire (20), a pair of guides (4) annularly fixed on the inner periphery surface of the rim (3), a pair of walls (5) annularly fixed in two side areas along the wheel axial direction on the outer periphery surface of a base rim (2) disposed on the disk (1) or on the outer periphery surface of the disk (1), and rubber elastic bodies (6) each annularly interposed between the side faces of the guides (4) and the side faces of the walls (5), wherein at least one belt (8) is annularly arranged on each rubber elastic body (6). By virtue of the shear deformation of the installed rubber elastic bodies (6), it is possible to absorb vibration, particularly to improve a riding quality associated with a low input, and to improve a vibration prevention performance, a sound insulation performance and a steering stability. As for sound insulation performance, the elastic wheel is extremely effective for sound insulation in high frequency ranges of 100 Hz or more.

### TECHNICAL FIELD

The present invention relates to an elastic wheel for use as a vehicle wheel, particularly to an elastic wheel excellent in riding quality, vibration prevention performance, sound insulation performance, as well as steering stability.

### BACKGROUND ART

An elastic wheel substantially comprises a disk to be fixed on a vehicle axle hub and a rim supporting a tire, and there have been suggested various elastic wheels each including a vibration prevention body provided between the disk and the rim, thus ensuring an improved vibration prevention performance and an improved riding quality. For example, Japanese Unexamined Utility Model Registration Application Publication No. 59-188701 has suggested a wheel, for use in a tire, using a spring as a vibration preventing body to improve a vehicle's riding quality.

Further, it is known that rubber can be used as a vibration preventing body and can be interposed between the rim and the disk. For example, Japanese Unexamined Utility Model Registration Application Publication No. 57-73203 has suggested an elastic wheel in which the rim is connected with the disk through an elastic body such as rubber. Moreover, Japanese Unexamined Patent Application Publication No. 5-338401 has suggested an elastic wheel in which a gap is formed between the rim and the elastic wheel and such a gap is then filled in with a vibration preventing rubber. In addition, WO98/33666 has disclosed a wheel/barrier assembly in which an annular rubber stopper is interposed between a rim and an inner rim having an identical profile with the rim.

However, with regard to the aforementioned conventional elastic wheels in which rubber is used as a vibration preventing body interposed between the rim and the disk, since the rubber elastic bodies are respectively fixed between the inner periphery surface of the rim and the outer periphery surface of the disk through vulcanization bonding, although it is possible to exactly control various vibrations propagating from the rim to the disk through the rubber elastic bodies in the axial direction and the radial direction as well as in the rotating direction, there has been a problem in that it is impossible to control the displacement of the rubber elastic bodies when there is a heavy load. Namely, since the cross section of all the rubber is the same everywhere, it is difficult to obtain an appropriate vibration prevention performance under all conditions including a low input and a high input. The same problem will also occur in an example where a spring is used as a vibration preventing body.

Moreover, a relationship between the rubber (interposed between the rim and the disk) and the sound prevention performance as well as the steering stability has not been made clear, and there is still a lot which has to be done to improve the sound insulation performance and the steering stability.

In view of the above, it is an object of the present invention to provide an elastic wheel capable improving the riding quality, the vibration prevention performance and the sound insulation performance at any time including a low input and a high input, without hindering durability, safety and steering stability.

### DISCLOSURE OF INVENTION

The inventors of the present invention have conducted their research repeatedly in order to solve the above-mentioned problems, while still making use of an advantage provided by rubber elastic material serving as vibration preventing means. As a result, it was found that the object of the present invention can be achieved by the following manner, thereby accomplishing the present invention. Namely, an elastic wheel formed according to the present invention is constituted as follows.

Namely, the present invention is an elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, whererin at least one belt is annularly arranged on the rubber elastic bodies.

Using the above arrangement, it is possible to absorb vibration by virtue of shear deformation of the installed rubber elastic bodies, particularly to improve the riding quality, the vibration prevention performance and the sound insulation performance when there is a low input. As for sound insulation performance, the elastic wheel is extremely effective for sound insulation in high frequency ranges of 100 Hz or more. Further, by making use of the at least one belt provided on the rubber elastic bodies, it is possible to obtain a high spring rigidity ratio in the wheel axial direction and torsional direction with respect to a spring constant in the wheel eccentric direction, and to obtain a high steering stability, as compared with a case in which only the volume of the rubber elastic bodies has been increased.

Here, with regard to the aforesaid elastic wheel, the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly disposed on the inner periphery surface of the substantially U-shaped guide assembly in a manner such that a gap is formed between the rubber elastic body and the disk or the outer periphery surface of the base rim, and is integrally formed with the rubber elastic bodies annularly interposed between the side faces of the guides and the side faces of the walls, and the belt is annularly disposed on the inner periphery surface of the integrally formed rubber elastic body. Alternatively, the width between the pair of guides in the wheel axial direction is larger than the width between the pair of walls in the wheel axial direction, the outer end portions of the pair of walls in the wheel radial direction are combined with each other so as to form an inverted substantially U-shaped cross section in the wheel axial direction, a rubber elastic body is annularly disposed on the outer periphery surface of the inverted substantially U-shaped wall assembly in a manner such that a gap is formed between the rubber elastic body and the inner periphery surface of the rim, and is integrally formed with the rubber elastic bodies interposed between the side faces of the guides and the side faces of the walls, and the belt is annularly disposed on the outer periphery surface of the integrally formed rubber elastic body. In this way, it is possible to exactly obtain the aforementioned effects, and to prevent significant deformation against a high input, by virtue of a compression action of the rubber elastic bodies disposed on the inner periphery surface of the substantially U-shaped guide assembly or on the outer periphery surface of the inverted substantially U-shaped wall assembly.

Further, with the above elastic wheel, the belt is preferred to be a steel belt formed by burying steel cords in rubber. In particular, an introduction angle of the steel belt is preferred to be substantially a right angle with respect to the wheel circumferential direction. In this way, it is possible to exactly obtain the aforesaid advantage of the present invention, particularly to increase the spring rigidity ratio in the axial direction.

Furthermore, according to the present invention, there is provided an elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, wherein one or both of the side faces on which the rubber elastic bodies are fixed have uneven portions.

Using the above arrangement, it is possible to absorb vibration by virtue of shear deformation of the installed rubber elastic bodies, particularly to improve the riding quality, the vibration prevention performance and the sound insulation performance when there is a low input. As for sound insulation performance, the elastic wheel is extremely effective for sound insulation in high frequency renges of 100 Hz or more. Further, since uneven portions are formed on the surfaces on which rubber elastic bodies are fixed, an entire bonding area can be increased. Therefore, as compared with an example in which rubber elastic body bonding surfaces are flat, it is allowed to more firmly fix the rubber elastic bodies and to increase a wheel torsional rigidity, thus improving a steering stability.

Here, the aforesaid uneven portions are preferred to be in a corrugated form. In this way, it is possible to exactly obtain the aforesaid effects, without bringing about any damage to the guides with which the rubber elastic bodies are fixed, and without damaging the strength of the walls. Moreover, it is possible to inhibit a rigidity rising in the vertical direction of the wheel and to maintain good sound insulation performance and good riding quality. Further, it is preferable that the aforesaid uneven portions be formed on both of every two mutually facing side faces on which the rubber elastic bodies are to be fixed, and that uneven portions formed on every two mutually facing side faces be complementary to each other. Therefore, it is possible to more exactly affect a shear deformation of the rubber elastic bodies and thus more exactly obtain the aforesaid advantages. In addition, it is possible to reduce the rigidity in the wheel vertical direction and to ensure a uniform rigidity in the wheel circumferential direction. Moreover, with the above-descried elastic wheel, the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly interposed between the inner periphery surface of the substantially U-shaped guide assembly and the disk or the outer periphery surface of the base rim, in a manner such that a gap is formed between the rubber elastic body and one of said periphery surfaces. Alternatively, the width between the pair of guides in the wheel axial direction is larger than the width between the pair of walls in the wheel axial direction, the outer end portions of the pair of guides in the wheel radial direction are combined with each other so as to form an inverted substantially U-shaped cross section in the wheel axial direction, a rubber elastic body is annularly interposed between the outer periphery surface of the inverted substantially U-shaped guide assembly and the inner periphery surface of the rim, in a manner such that a gap is formed between the rubber elastic body and one of said periphery surfaces. In this way, it is possible to exactly obtain the aforesaid effects and to prevent some significant deformation possibly caused by a high input, by virtue of a compressing action produced by the rubber elastic bodies disposed on the outer periphery surface of the base rim or on the inner periphery surface of the rim.

Furthermore, according to the present invention, there is provided an elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, wherein the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly disposed on the inner periphery surface of the substantially U-shaped guide assembly in a manner such that a gap is formed between the rubber elastic body and the disk or the outer periphery surface of the base rim, and is integrally formed with the rubber elastic bodies annularly interposed between the side faces of the guides and the side faces of the walls. In particular, a spring is wound within the integrally formed rubber elastic body along the wheel circumferential direction. Alternatively, there is provided an elastic wheel comprising a disk, a rim supporting a tire, a pair of walls annularly fixed on the outer periphery surface of a base rim disposed on the disk or on the outer periphery surface of the disk, a pair of guides annularly fixed in two side areas along the wheel axial direction on the inner periphery surface of the rim, and rubber elastic bodies annularly interposed between the side faces of the guides and the side faces of the walls, wherein the width between the pair of guides in the wheel axial direction is larger than the width between the pair of walls in the wheel axial direction, the outer end portions of the pair of walls in the wheel radial direction are combined with each other so as to form an inverted substantially U-shaped cross section in the wheel axial direction, a rubber elastic body is annularly disposed on the outer periphery surface of the inverted substantially U-shaped guide assembly in a manner such that a gap is formed between the rubber elastic body and the inner periphery surface of the rim, and is integrally formed with the rubber elastic bodies annularly interposed between the side faces of the guides and the side faces of the walls. In particular, a spring is wound within the integrally formed rubber elastic body in the wheel circumferential direction.

By virtue of the above arrangement, it is possible to absorb vibration by virtue of shear deformation of the installed rubber elastic bodies, particularly to improve the riding quality, the vibration prevention performance and the sound insulation performance when there is a low input. Meanwhile, by virtue of an action of the spring imbedded in the rubber elastic bodies, it is possible to provide a higher wheel rigidity in the lateral and circumferential directions than in the vertical direction, thereby improving the steering stability. Further, as for sound insulation performance, the elastic wheel is extremely effective for sound insulation in high frequency ranges of 100 Hz or more.

Here, with regard to the above-described elastic wheel, it is preferable that the spring be wound within each rubber elastic body, covering the entire width of each rubber elastic body in the wheel axial direction. In this way, it is possible to uniformly increase a resistance against the load on each rubber elastic body, thereby making it possible to best obtain the above-discussed advantages. Further, it is preferable that the number of windings of the spring be 2-9 for every 10 mm of width in the wheel axial direction, while the cross section area of the steel wire forming the spring is preferred to be 0.8-7 mm². By virtue of this, it is possible to optimize the spring which is to be imbedded in rubber, thereby making it possible to properly adjust the rigidity. Besides, it is also possible for the cross section of the steel wire forming the spring to be made rectangular, thereby effectively ensuring an advantage of improving the rigidity.

### BRIEF DESCRIPTION OF THE DRAWINGS

FIG. 1 is a partially enlarged sectional view of an elastic wheel according to one embodiment of the present invention.

FIG. 2 is an enlarged view showing one part of the wheel illustrated in FIG. 1.

FIG. 3 is a partially enlarged sectional view of an elastic wheel according to another embodiment of the present invention.

FIG. 4 is a partially enlarged sectional view of an elastic wheel according to a further embodiment of the present invention.

FIG. 5 provides several cross sectional views taken along line A-A in FIG. 4.

FIG. 6 is a partially enlarged sectional view of an elastic wheel according to a still further embodiment of the present invention.

FIG. 7 shows several cross sectional views taken along line B-B in FIG. 6.

FIG. 8 is a partially enlarged sectional view of an elastic wheel according to one more embodiment of the present invention.

FIG. 9 is a partially enlarged sectional view of an elastic wheel according to one more embodiment of the present invention.

FIG. 10 is a partially enlarged sectional view of an elastic wheel according to one more embodiment of the present invention.

### BEST MODE FOR CARRYING OUT THE INVENTION

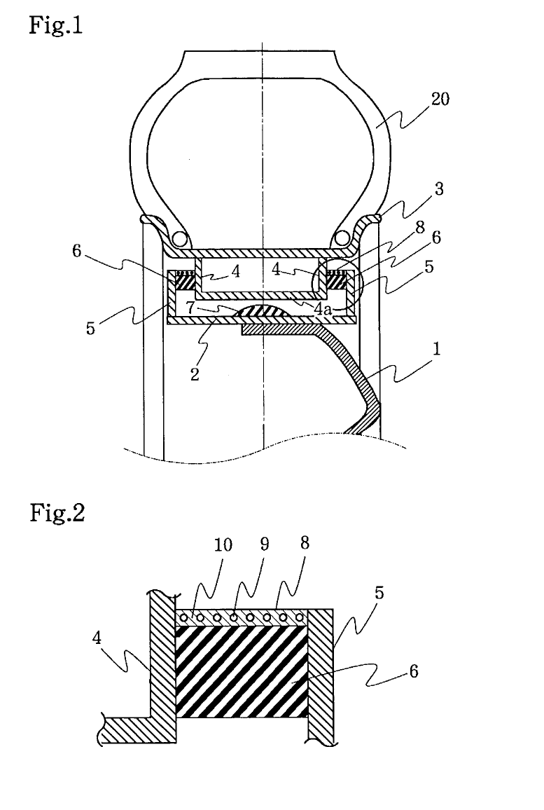

As shown in FIG. 1, an elastic wheel according to one embodiment of the present invention is formed such that a disk 1 to be fixed on an axle hub (not shown) has a base rim 2. Here, the disk 1 and the base rim 2 are integrally formed together by means of molding. Alternatively, it is possible to use a spoke wheel or a mesh wheel combined with a supporting body such as a spoke or mesh. In practice, a material forming the disk 1 may be any one of steel, aluminum, magnesium and synthetic resin. However, if it is desired to obtain a vehicle wheel light in weight, it is preferable to use aluminum or synthetic resin.

In addition, a pair of guides 4 are annularly fixed on the inner periphery surface of a rim 3 supporting a tire 20, while the end portions of the pair of guides 4 in the radial direction of the wheel are combined with each other, in a manner such that a substantially U-shaped cross section is formed in the wheel axial direction. In this way, the pair of guides 4, by forming the substantially U-shaped cross section in the wheel axial direction, can function as a stopper in cooperation with the inner periphery surface 4a formed by the guides as well as a rubber elastic body 7 which will be described later, thereby making it possible to deal with a large input. The shape of the rim 3 should not be limited, but is selectable depending upon its actual use. In fact, it is allowed to employ those not belonging to standardized products, such as a rim whose diameters at their end portions are different from each other. Besides, it is possible for the pair of guides 4 to be formed by causing the cross section of the rim 3 in the wheel axial direction to display a recess portion, i.e., to protrude inwardly in the wheel radial direction.

Furthermore, a pair of walls 5 are annularly fixed on the outer periphery surface of the base rim 2 at two ends in the axial direction, in a manner such that the width between the walls is larger than the width between the guides 4 in the wheel axial direction. Between the two outer surfaces of the two guides 4 and the two inner surfaces of the two walls 5, there are annularly provided rubber elastic bodies 6 which are fixed therein through a bonding process such as vulcanization bonding, while belts 8 are disposed on the outer periphery surfaces of the rubber elastic bodies 6, as shown in an enlarged view of FIG. 2.

However, the position of the belts 8 in the present invention does not have to be limited to the outer periphery surfaces of the rubber elastic bodies 6. In fact, it is possible for the belts 8 to be disposed on the inner surface of the rubber elastic bodies 6. Moreover, such rubber elastic bodies are also allowed to be disposed on both the upper and lower surfaces of the belts 8. In addition, although the present embodiment shown in the drawing indicates that the belts 8 are disposed to cover the whole width of the rubber elastic bodies 6 in the wheel axial direction, it is also allowable for the belts 8 to cover only part of the rubber elastic bodies 6 to obtain the similar effect. Furthermore, since a rising rate of a spring rigidity ratio in the wheel axial direction and the wheel torsional direction will be different depending upon an angle at which cords are introduced into the belts 8, it is preferable to select an appropriate angle for introducing the cords into the belts 8, in accordance with an actual use. Besides, the belts 8 do not have to be limited to only one layer, but is allowed to be in a multiple form including a plurality of belts laminated one above another. At this time, if a plurality of belts are arranged in a manner such that cords 9 imbedded within these belts intersect one another, it is possible to properly increase the spring rigidity ratio in the wheel axial direction and the wheel torsional direction.

The belt 8 suitable for use in the present invention is allowed to be the same as that used in a radial tire or the like. For example, as the reinforcing cords 9, it is possible to use not only steel cords, but also organic fiber cords such as aramid fiber cords. Further, the number of cords to be introduced into each belt may also be in the same range usually for use in a radial tire or the like. Moreover, although there is no particular limitation to a covering rubber 10 forming the belt, it is preferable for the covering rubber 10 to be formed by the same rubber used in forming the rubber elastic bodies 6, or to be formed by a rubber having a good adhesion with the rubber elastic bodies 6.

In the preferred embodiment shown in FIG. 1, another rubber elastic body 7 is annularly interposed between the inner periphery surface 4a formed by the guides 4 and the outer periphery surface of the base rim 2. Such rubber elastic body 7 is bonded to the outer periphery surface of the base rim 2, through a bonding process such as vulcanization bonding, with a gap formed between the rubber elastic body and the inner periphery surface 4a formed by the guides 4. Alternatively, the rubber elastic body 7 may be bonded to the inner periphery surface 4a formed by the guides 4, while a gap is formed between the rubber elastic body and the outer periphery surface of the base rim 2.

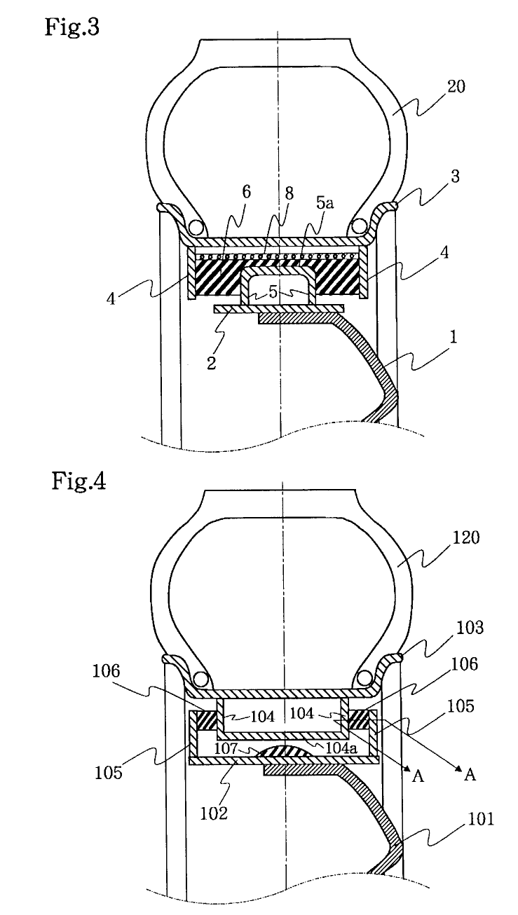

Next, a description will be given to explain an elastic wheel formed according to another embodiment of the present invention. This preferred embodiment, as shown in FIG. 3, is formed such that a width between the pair of walls 5 in the wheel axial direction, which are fixedly provided on both sides of the outer periphery surface of the base rim 2, is narrower than the width between the pair of guides 4 in the wheel axial direction. At this time, the rubber elastic body 6 is annually attached between the two inner surfaces of the guides 4 and the two outer surfaces of the walls 5. Further, the outer end portions of the pair of walls 5 in the wheel radial direction are integrally combined together in a manner shown in the drawing, so that an inverted substantially U-shaped cross section is formed in the wheel axial direction. Moreover, the rubber elastic body 6, serving as a stopper, is provided also between the outer periphery surface 5a formed by the walls 5 and the inner surface of the rim 3. Here, the walls 5 can be directly provided on the outer periphery surface of the disk 1. For example, the walls 5 may be provided by annularly forming projections in the circumferential direction on the outer periphery surface of the disk 1.

The rubber elastic body 6, as shown in FIG. 3, is formed to provide a function as a stopper, by allowing the rubber elastic material to extend above the outer periphery surface 5a and by forming a integral body. In this way, it is possible to obtain the exact same effect as obtainable from the elastic wheel formed according to the preferred embodiment of the present invention shown in FIG. 1. In other words, when an input is not extremely large, it is possible to greatly improve the vehicle's riding quality, vibration prevention performance and sound insulation performance, by virtue of a shearing action provided by the rubber elastic body 6. Moreover, even when an input becomes large, it is still possible to prevent a significant distortion by virtue of a compression action of the rubber elastic body 6 located above the outer periphery surface 5a.

Furthermore, in the preferred embodiment shown in FIG. 3, the belt 8 is disposed on the outer periphery surface of the rubber elastic body 6 integrally formed between the pair of guides 4. The structure and the arrangement of the belt 8 may be properly selected in the same manner as described above depending on how it will be used. In this way, it is possible to obtain the vibration prevention effect and the sound insulation effect, as well as the desired steering stability.

A further elastic wheel formed according to a further embodiment of the present invention shown in FIG. 4 is formed such that a disk 101 to be fixed on an axle hub (not shown) has a base rim 102. Here, the disk 101 and the base rim 102 may be integrally formed together by means of molding. Alternatively, it is possible to use a spoke wheel or a mesh wheel combined with a supporting body such as a spoke or mesh. In practice, a material forming the disk 101 may be any one of steel, aluminum, magnesium and synthetic resin. However, if it is desired to obtain a vehicle wheel light in weight, it is preferable to use aluminum or synthetic resin.

In addition, a pair of guides 104 are annularly fixed on the inner periphery surface of a rim 103 supporting a tire 120, while the end portions of the pair of guides 104 in the radial direction of the wheel are combined with each other, in a manner such that a substantially U-shaped cross section is formed in the wheel axial direction. In this way, the pair of guides 104, by forming the substantially U-shaped cross section in the wheel axial direction, can function as a stopper in cooperation with the inner periphery surface 104a formed by the guides as well as a rubber elastic body 107 which will be described later, thereby enabling them to deal with a large input. The shape of the rim 103 should not be limited, but is selectable depending upon its actual use. In fact, it is allowed to employ those not belonging to standardized products, such as a rim whose diameters at their end portions are different from each other. Besides, it is also possible for the pair of guides 104 to be formed by causing the cross section of the rim 103 in the wheel axial direction to display a recess portion, i.e., to protrude inwardly in the wheel radial direction.

Furthermore, a pair of walls 105 are annularly fixed on the outer periphery surface of the base rim 102 at two ends in the axial direction, in a manner such that the width between the walls is larger than the width between the guides 104 in the wheel axial direction. Between the two outer surfaces of the two guides 104 and the two inner surfaces of the two walls 105, there are annularly provided rubber elastic bodies 106 bonded therein through a bonding process such as vulcanization bonding.

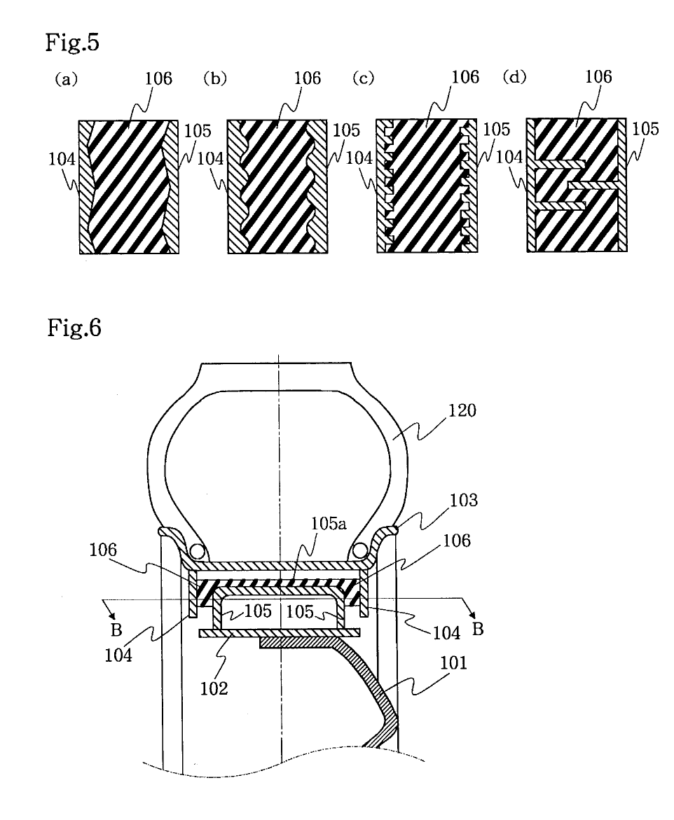

In the present invention, it is important that the two outer surfaces of the two guides 104 and the two inner surfaces of the two walls 105 be formed into uneven surfaces, so that total bonding area between these surfaces and the rubber elastic bodies can be increased as compared with the case in which these surfaces are flat, thereby making it possible to more firmly fix the rubber elastic bodies through a bonding process such as vulcanization bonding. On the other hand, although there is no limitation to the shape of the uneven surfaces, it is preferable to form corrugated surfaces since a corrugated surface is easy to form and can offer a satisfactory strength. In more detail, it is possible to form the uneven surfaces as shown in FIGS. 5(a)-5(d) which are circumferentially sectional views taken along line A-A in FIG. 4. At this time, it is preferable that the uneven portions of every two mutually facing uneven surfaces be made complementary to each other, so that it is possible to effectively obtain a desired shear deformation of the rubber elastic bodies 106, thereby inhibiting an undesired rising of the rigidity of the wheel in the vertical direction, and also prohibiting an non-uniform rigidity in the circumferential direction. However, where the uneven portions are those shown in FIG. 5(d), it is preferable that such uneven portions be provided in several positions at an equal interval in the circumferential direction, more preferably in 6-8 positions.

In the preferred embodiment shown in FIG. 4, another rubber elastic body 107 is annularly interposed between the inner periphery surface 104a formed by the guides 104 and the outer periphery surface of the base rim 102. Such a rubber elastic body 107 is bonded to the outer periphery surface of the base rim 102, through a bonding process such as vulcanization bonding, with a gap formed between the rubber elastic body and the inner periphery surface 104a formed by the guides 104. Alternatively, the rubber elastic body 107 may be bonded to the inner periphery surface 104a formed by the guides 104, while a gap is formed between the rubber elastic body and the outer periphery surface of the base rim 102.

In the following, a description will be given to explain an elastic wheel formed according to a still further embodiment of the present invention. This preferred embodiment, as shown in FIG. 6, is such that a width between the pair of walls 105 in the wheel axial direction, which are fixedly provided on both sides of the outer periphery surface of the base rim 102, is narrower than the width between the pair of guides 104 in the wheel axial direction. At this time, the rubber elastic bodies 106 are annually attached between the two inner surfaces of the guides 104 and the two outer surfaces of the walls 105. Further, the outer end portions of the pair of walls 105 in the wheel radial direction are integrally combined together in a manner shown in the drawing, so that an inverted substantially U-shaped cross section is formed in the wheel axial direction. Moreover, a rubber elastic body 106 serving as stopper is provided also between the outer periphery surface 105a formed by the walls 105 and the inner surface of the rim 103. Here, the walls 105 can also be directly provided on the outer periphery surface of the disk 101. For example, although not shown in the drawing, the walls 105 may be provided by annularly forming projections in the circumferential direction on the outer periphery surface of the disk 101.

A method of annularly attaching the rubber elastic body may be carried out in the following manner. For example, the rubber elastic body is bonded to the inner periphery surface of the rim 103, in a manner such that a gap is formed between the rubber elastic body and the outer periphery surface 105a. Alternatively, the rubber elastic body is bonded to the outer periphery surface 105a, in a manner such that a gap is formed between the rubber elastic body and the inner periphery surface of the rim 103. In addition, it is also possible to use another method shown in FIG. 6. Namely, a pair of rubber elastic bodies 106 may be disposed to extend above the outer periphery surfaces 105a and are combined together so as to form an integral body, thereby providing a function as a stopper. In this way, it is possible to obtain the exact same effect as obtainable from the elastic wheel shown in FIG. 4 illustrating a preferred embodiment of the present invention. This means that it is possible to sufficiently improve the riding quality, the vibration prevention performance and the sound insulation performance by virtue of the rubber elastic body 106, provided that an input is not extremely large. Further, even if an input becomes large, it is still possible to prevent a significant distortion by virtue of a compression action produced by the rubber elastic body 106 located above the outer periphery surfaces 105a.

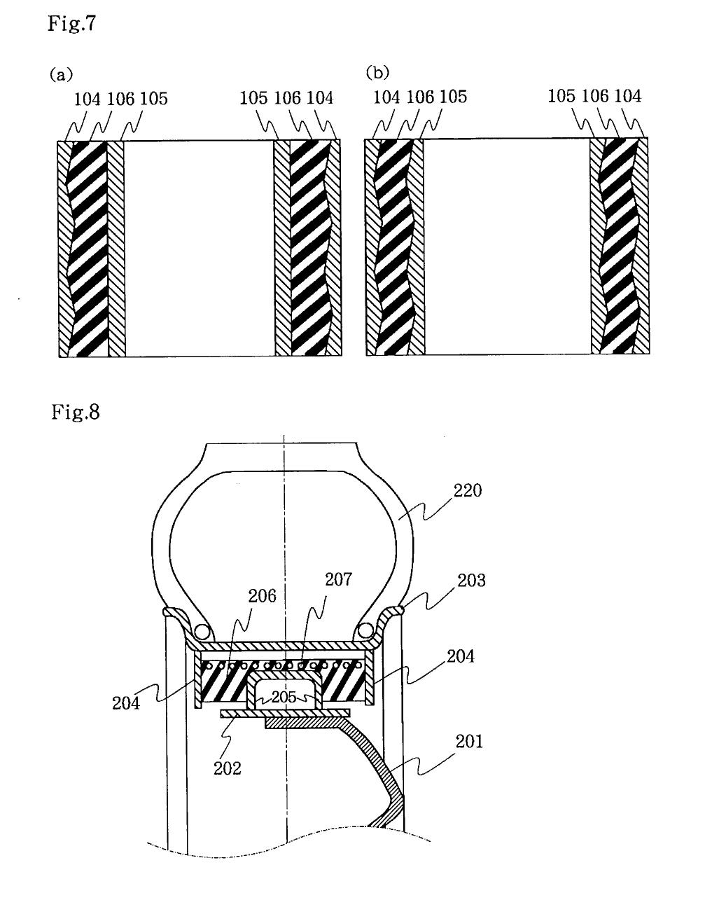

In the present invention, it is important that at least the two inner surfaces of the two guides 104 be formed into uneven surfaces. In fact, it is possible to form the uneven surfaces as shown in FIGS. 7(a) and 7(b) which are circumferentially sectional views taken along line B-B in FIG. 6. In FIG. 7(a), the two inner surfaces of the two guides 104 are formed into uneven surfaces, while the outer surfaces of the walls 105 are kept in their original flat state. On the other hand, in FIG. 7(b), both the inner surfaces of the guides 104 and the outer surfaces of the walls 105 have been formed into uneven surfaces. Actually, similar to the above-described preferred embodiments, there should not be any limitation to the shape of the uneven surfaces.

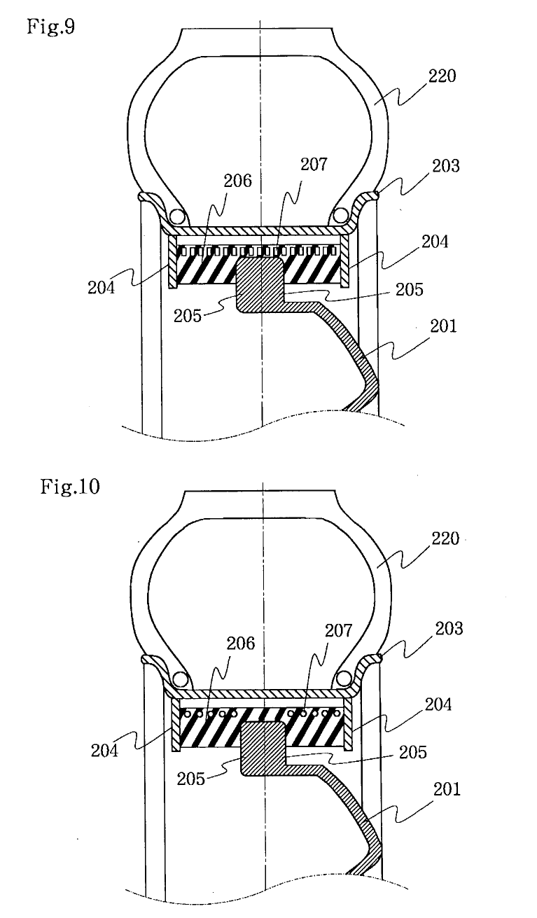

An elastic wheel according to a still further embodiment of the present invention shown in FIG. 8 is formed such that a disk 201 to be fixed on an axle hub (not shown) has a base rim 202. Here, the disk 201 and the base rim 202 may be integrally formed together by means of molding, as shown in FIG. 9 and FIG. 10. Alternatively, it is possible to use a spoke wheel or a mesh wheel combined with a supporting body such as a spoke or mesh. In practice, a material forming the disk 201 may be any one of steel, aluminum, magnesium and synthetic resin. However, if it is desired to obtain a vehicle wheel light in weight, it is preferable to use aluminum or synthetic resin.

Further, a pair of guides 204 are annularly fixed on the inner periphery surface of a rim 203 supporting a tire 220, on both sides of the wheel axial direction. The shape of the rim 203 should not be limited, but is selectable depending upon its actual use. In fact, it is allowed to employ those not listed in the standardized products, such as a rim whose diameters at their end portions are different from each other. Besides, it is also possible for the pair of guides 204 to be formed by causing the cross section of the rim 203 in the wheel axial direction to display a recess portion, i.e., to protrude inwardly in the wheel radial direction.

Furthermore, a pair of walls 205 are annularly fixed on the outer periphery surface of the base rim 202, in a manner such that a width between the pair of walls 205 is narrower than the width between the guides 204 in the wheel axial direction. The outer end portions of the pair of walls 205 in the radial direction of the wheel are combined with each other, in a manner such that an inverted substantially U-shaped cross section is formed in the wheel axial direction. Between the two inner surfaces of the two guides 204 and the two outer surfaces of the two walls 205, there is annularly provided a rubber elastic body 206 bonded therein through a bonding process such as vulcanization bonding. The rubber elastic body 206, as shown in the drawing, is extending to the outer periphery surface of the substantially U-shaped configuration formed between the walls 205. In fact, the rubber elastic body 206 is interposed in a manner such that a gap is formed between the rubber body and the inner periphery surface of the rim 203, thereby serving as a stopper for dealing with a high input. Moreover, the walls 205, as shown in FIG. 9 and FIG. 10, can also be formed by annularly providing a projection on the outer periphery surface of the disk 201.

In the preferred embodiment shown in FIG. 8, the integrally formed rubber elastic body 206 is interposed between the pair of guides 204, while a spring 207 is buried within the rubber elastic body 206 in the circumferential direction of the wheel. With the use of the spring 207, it is possible to obtain a higher rigidity in the circumferential direction than in the vertical direction. Therefore, apart from an effect of improving the riding quality, the vibration prevention performance and the sound insulation performance, all by absorbing vibration using the shear deformation of the rubber elastic body 206, it is also possible to obtain an improved steering stability. In this way, with the use of the present invention, it becomes possible to improve various performances, dealing with various inputs including a low input and a high input.

On the other hand, in contrast to the present embodiment shown in the drawing, if the width between the pair of the guides 204 in the wheel axial direction, fixed on the inner periphery surface of the rim 203, is narrower than the width between the pair of walls 205 in the wheel axial direction, and if the inner end portions of the guides 204 in the wheel radial direction are combined with each other to form a substantially U-shaped cross section in the wheel axial direction, the rubber elastic body 206 should be interposed between the two outer surfaces of the two guides 204 and the two inner surfaces formed of the two walls 205, and are allowed to extend to the inner surface formed by the guides 204 in the U-shaped configuration, with a gap formed between the rubber elastic body 206 and the outer periphery surface of the base rim 202. At this time, by burying the spring 207 in the rubber elastic body 206 interposed between the pair of the walls 205, it is possible to obtain the same effects as obtainable in the above-described embodiments.

The specifications, arrangement and number of layers of the spring 207 should not be limited, but can be properly selected so as to obtain a desired rigidity. Specifically, in order to obtain an effect of uniformly improving rigidity with respect to a load on the rubber elastic body 206, it is preferable for the spring 207 to be uniformly wound within the rubber elastic body 206, covering the entire width of the rubber elastic bodies in the wheel axial direction. On the other hand, as shown in FIG. 10, the spring 207 may be disposed only in both side areas of the rubber elastic body 206, since the disk 201 which is integrally formed with the base rim 202 and the walls 205, is not present in these side areas over the width in the wheel axial direction. As a spring for use in the present embodiment, it is preferable to employ one whose number of windings is 2-9 for every 10 mm of width in the wheel axial direction. Further, in order to ensure an effect of improving rigidity, the cross section of a steel wire forming the spring is preferred to be rectangular (shown in FIG. 9), rather than circular (shown in FIG. 8 and FIG. 10). However, by using such a spring, it is slightly difficult to provide a desired durability against fatigue. Moreover, the cross sectional area of the steel wire is preferred to be 0.8-7 mm².

In the preferred embodiments shown in FIGS. 8-10, the rubber elastic body 206 is interposed to extend from between the two outer surfaces of the inverted substantially U-shaped wall assembly 205 and the two inner surfaces of the guides 204, to the outer periphery surface of the inverted substantially U-shaped wall assembly 205. As a result, when an input becomes high, a stopper function will act between the outer periphery surfaces of the walls 205 and the inner periphery surface of the rim 203. On the other hand, when an input is not extremely high, it is possible to sufficiently improve the riding quality, the vibration prevention performance and the sound insulation performance by virtue of a shearing action of the rubber elastic body 206 interposed between the walls 205 and the guides 204. Moreover, it is also possible to prevent a significant deformation by virtue of a compression action produced by the rubber elastic body 206.

The rubber elastic bodies used in the present invention may be those well known as vibration prevention rubbers, and can be prepared by mixing an appropriate additive into a natural rubber or a synthetic rubber. Here, a natural rubber or a synthetic rubber may be a diene rubber such as butadiene rubber, styrene-butadiene copolymer rubber and butyl rubber, while an additive may be sulfur, a vulcanization accelerator, an antioxidant or carbon black. JIS-A hardness (Hd) of each rubber elastic body is preferred to be 30-80° in order to ensure a satisfactory vibration absorbing performance and a satisfactory durability, while its elastic modulus is 1×10³-10⁵ N/cm².

Next, the present invention will be further described through several examples.

### EXAMPLE 1

An elastic wheel having a structure shown in FIG. 3 was fabricated under the following conditions.

(Rim)

size: 15 in

width: 5.5 J

(Rubber Elastic Bodies)

dimension: vertical size: 11 mm; longitudinal size: 15 mm

JIS-A hardness: 60°

elastic modulus: 4×10⁴ N/cm²

distance between the rim and the base rim in wheel radial direction: 25 mm

distance between the outer periphery surface of the rubber elastic body 6 and the inner periphery surface of the rim 3: 6 mm

(Belt)

number of belts: 1

cord: steel cord (1×5×0.23 (mm))

cord introducing angle: 90° with respect to the circumferential direction

number of introduced cords: 36 lengths/50 mm

imbedded rubber: the same as the above-described rubber elastic bodies.

### EXAMPLE 2

An elastic wheel was fabricated in the same manner as in Example 1, except that an angle for introducing cords into the belt 8 is 45° with respect to the circumferential direction.

### EXAMPLE 3

An elastic wheel was fabricated in the same manner as in Example 1, except that an angle for introducing cords into the belt is 0° with respect to the circumferential direction.

### COMPARATIVE EXAMPLE 1

An elastic wheel was fabricated in the same manner in Example 1, except that the belt 8 was not used.

The elastic wheels fabricated in Examples 1-3 and Comparative Example 1 were tested to measure the respective constants of vertical springs in elastic portions, springs in the wheel axial direction and torsional springs, with the results shown in Table 1.

TABLE 1

| | | | | Comparative |
|---|---|---|---|---|
| | Example 1 | Example 2 | Example 3 | Example 1 |
| Vertical spring | 201 | 235 | 174 | 158 (1) |
| (kgf/mm) | | | | |
| Axial spring | 1161 | 907 | 888 | 801 |
| (kgf/mm) | | | | |
| Torsional spring | 831 | 1260 | 837 | 744 |
| 10² (kgf · mm/° | | | | |

Tires having a size of 185/55R15 were attached to the elastic wheels obtained in Examples 1-3 as well as in Comparative Example 1, and their steering stabilities were evaluated. It was confirmed that any one of the rubber elastic wheels obtained in any one of the above Examples could provide a more satisfactory steering stability than the elastic wheel obtained in the Comparative Example 1. However, it was found that the elastic wheels obtained in both Examples and the Comparative Example could absorb vibration by virtue of shear deformation of the rubber elastic bodies when an input was low, and could inhibit a significant distortion by virtue of a compression input from one rubber elastic body when an input was higher. Further, it was understood from the result of a test on a sound insulation performance that these elastic wheels were extremely effective for sound insulation in high frequency ranges of 100 Hz or more.

### EXAMPLE 4

Under the following conditions, an elastic wheel was fabricated which has a structure shown in FIG. 6 and in which rubber elastic bodies having a configuration shown in FIG. 7(a) have been annularly attached. A tire having a size of 185/55R15 was attached to the elastic wheel obtained in this Example, and its vibration absorbing stability, sound insulation performance and durability were evaluated.

(Rim)

size: 15 in

width: 5.5 J

(Rubber Elastic Bodies)

dimension: vertical size: 11 mm; longitudinal size: 15 mm

JIS-A hardness: 60°

elastic modulus: 4×10⁴ N/cm²

distance between the rim and the base rim in wheel radial direction: 25 mm

distance between the outer periphery surface of the rubber elastic body 106 and the inner periphery surface of the rim 103: 6 mm

### COMPARATIVE EXAMPLE 2

For the purpose of comparison, another elastic wheel was fabricated in the same method as in the above Examples, except that the inner surfaces of the guides 104 and the two outer surfaces of the walls 105 were all flat.

It was confirmed that the elastic wheels obtained in both Example 4 and Comparative Example 2 can all absorb vibration by virtue of shear deformation of rubber elastic bodies when an input is low, and can also inhibit a significant distortion by virtue of a compression input from one rubber elastic body when an input is large. It was also confirmed that the rubber elastic body 106 in Example 4 can be more firmly fixed on the two inner surfaces of the guides 104 than the rubber elastic body in Comparative Example 2. In addition, it was found that the elastic wheel in Example 4 can offer more satisfactory steering stability and riding quality than the elastic wheel in Comparative Example 2. Moreover, it was understood from the result of a test on a sound insulation performance that the elastic wheels obtained in both Example 4 and Comparative Example 2 are extremely effective for sound insulation in high frequency renges of 100 Hz or more.

### INDUSTRIAL APPLICABILITY

As described above, with the use of the elastic wheel formed according to the present invention, it is possible to improve the riding quality, the vibration prevention performance and the sound insulation performance at any time including a low input and a high input, without hindering durability, safety and steering stability.

1. An elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, wherein at least one belt is annularly arranged on the rubber elastic bodies.

2. An elastic wheel according to claim 1, wherein the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly disposed on the inner periphery surface of the substantially U-shaped guide assembly in a manner such that a gap is formed between the rubber elastic body and the disk or the outer periphery surface of the base rim, and is integrally formed with the rubber elastic bodies annularly interposed between the side faces of the guides and the side faces of the walls, said belt is annularly disposed on the inner periphery surface of the integrally formed rubber elastic body.

3. An elastic wheel according to claim 1, wherein the width between the pair of guides in the wheel axial direction is larger than the width between the pair of walls in the wheel axial direction, the outer end portions of the pair of walls in the wheel radial direction are combined with each other so as to form an inverted substantially U-shaped cross section in the wheel axial direction, a rubber elastic body is annularly disposed on the outer periphery surface of the inverted substantially U-shaped wall assembly in a manner such that a gap is formed between the rubber elastic bodies and the inner periphery surface of the rim, and is integrally formed with the rubber elastic bodies interposed between the side faces of the guides and the side faces of the walls, said belt is annularly disposed on the outer periphery surface of the integrally formed rubber elastic body.

4. An elastic wheel according to any one of claims 1-3, wherein said belt is a steel belt formed by imbedding steel cords in rubber.

5. An elastic wheel according to claim 4, wherein an introduction angle of the steel belt is substantially a right angle with respect to the wheel circumferential direction.

6. An elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, wherein one or both of the side faces on which the rubber elastic bodies are fixed have uneven portions.

7. An elastic wheel according to claim 6, wherein said uneven portions are corrugated portions.

8. An elastic wheel according to claim 6 or 7, wherein both of the side faces on which the rubber elastic bodies are fixed have uneven portions, and uneven portions on two mutually facing side faces are complementary to each other.

9. An elastic wheel according to any one of claims 6-8, wherein the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly interposed between the inner periphery surface of the substantially U-shaped guide assembly and the disk or the outer periphery surface of the base rim, in a manner such that a gap is formed between the rubber elastic body and one of said periphery surfaces.

10. An elastic wheel according to any one of claims 6-8, wherein the width between the pair of guides in the wheel axial direction is larger than the width between the pair of walls in the wheel axial direction, the outer end portions of the pair of guides in the wheel radial direction are combined with each other so as to form an inverted substantially U-shaped cross section in the wheel axial direction, a rubber elastic body is annularly interposed between the outer periphery surface of the inverted substantially U-shaped guide assembly and the inner periphery surface of the rim, in a manner such that a gap is formed between the rubber elastic body and one of said periphery surfaces.

11. An elastic wheel comprising a disk, a rim supporting a tire, a pair of guides annularly fixed on the inner periphery surface of the rim, a pair of walls annularly fixed in two side areas along the wheel axial direction on the outer periphery surface of a base rim disposed on the disk or on the outer periphery surface of the disk, and rubber elastic bodies annularly interposed between the side faces of the guides and the side faces of the walls, wherein the width between the pair of guides in the wheel axial direction is narrower than the width between the pair of walls in the wheel axial direction, the inner end portions of the pair of guides in the wheel radial direction are combined with each other so as to form a substantially U-shaped cross section in the wheel axial direction, a rubber elastic body is annularly disposed on the inner periphery surface of the substantially U-shaped guide assembly in a manner such that a gap is formed between the rubber elastic body and the disk or the outer periphery surface of the base rim, and is integrally formed with the rubber elastic bodies annularly interposed between the side faces of the guides and the side faces of the walls, a spring is wound within the integrally formed rubber elastic body along the wheel circumferential direction.

12. An elastic wheel comprising a disk, a rim supporting a tire, a pair of walls annularly fixed on the outer periphery surface of a base rim disposed on the disk or on the outer periphery surface of the disk, a pair of guides annularly fixed in two side areas along the wheel axial direction on the inner periphery surface of the rim, and rubber elastic bodies annularly interposed between the side faces of the guides and the side faces of the walls, wherein the width between the pair of guides in the wheel axial direction is larger than the width between the pair of walls in the wheel axial direction, the outer end portions of the pair of walls in the wheel radial direction are combined with each other so as to form an inverted substantially U-shaped cross section in the wheel axial direction, a rubber elastic body is annularly disposed on the outer periphery surface of the inverted substantially U-shaped guide assembly in a manner such that a gap is formed between the rubber elastic body and the inner periphery surface of the rim, and are integrally formed with the rubber elastic bodies annularly interposed between the side faces of the guides and the side faces of the walls, a spring is wound within the integrally formed rubber elastic body in the wheel circumferential direction.

13. An elastic wheel according to claim 11 or 12, wherein the spring is wound within the rubber elastic body and extends over the whole width in the wheel axial direction.

14. An elastic wheel according to any one of claim 11-13, wherein the number of windings of the spring is 2-9 for every 10 mm of width in the wheel axial direction.

15. An elastic wheel according to any one of claims 11-14, wherein the cross section of the steel wire forming the spring has a rectangular shape.

16. An elastic wheel according to any one of claims 11-15, wherein the cross section area of the steel wire forming the spring is 0.8-7 mm².
